(19) United States
(12) Patent Application Publication
(10) Pub. No.: US 2005/0048920 A1
(43) Pub. Date: Mar. 3, 2005

(54) Method of control signaling in wireless communications

(76) Inventor: Jung-Tao Liu, Madison, NJ (US)

Correspondence Address: JONES DAY, 222 EAST 41ST ST, NEW YORK, NY, 10017, US

(21) Appl. No.: 10/649,088

(22) Filed: Aug. 26, 2003

(51) Int. Cl. H04Q 7/00

(52) U.S. Cl. 455/63.1; 370/332

(57) ABSTRACT

The present invention provides for efficient control signaling in a downlink control channel that specifies the following information: MAC ID, HARQ channel ID, redundancy version, transport format, transport block size, new/continue data indicator and pilot boost/deboost. Optionally, the downlink control channel may also specify whether transmit time interval may be varied or fixed. Advantageously, this information may be supplied in a subframe that may be organized so as to specify in the first part of the frame information that can be used immediately by the remote terminal and to specify in a later part of the frame information that does not have to be used immediately. In particular, information such as the transport format, transport block size and new/continue data indicator may be advantageously specified in the first part of the frame and information such as the pilot boost/deboost may be specified in a later part of the same frame.

### FIELD OF THE INVENTION

This invention relates to telecommunications and, more particularly, to wireless communications.

### BACKGROUND OF THE INVENTION

To provide end users with the requisite service quality for multimedia communications, Internet access and video/picture transfer, high bit rate capabilities are required in wireless systems. Given such requirements, bearer capability targets for third generation wireless systems have been defined as 384 kilobits per second (kb/s) for full coverage area and 2 Megabits per second (Mb/s) for local area coverage.

Universal Mobile Telecommunications System (UMTS) is a radio access network based on 5 Megahertz Wideband Code Division Multiple Access (W-CDMA) and optimized for support of third generation services including multimedia-capable mobile communications. Since major design goals of UMTS are to provide a broadband multimedia communications system that integrates infrastructure for mobile and fixed communications and to offer, inter alia, the same range of services as provided by the fixed and wireless communications networks, UMTS must provide circuit-switched as well as packet-switched services, a variety of mixed media traffic types, and bandwidth-on-demand. However, providing multimedia support implies the need for flexibility, that is, being able to support services with different bit rates and different E_{b} /Nₒ requirements, and to multiplex such services in a multiservice environment. UMTS is designed to support such demands.

FIG. 1 is an illustrative block diagram of a UMTS access network. Particularly, a plurality of remote terminals 2 and 4 (e.g., mobile terminals) communicate with base stations 6, which are referred to as (NODE-BS) via W-CDMA wireless links 8. The remote terminals may be a variety of devices such as a wireless phone 2 or a portable personal computer 4 with an internal or external modem. Communication from the remote terminal to a base station is referred to as being in the uplink direction. Communication from a base station to a remote terminal is referred to as being in a downlink direction.

These base stations communicate with a network component that provides radio resource management functions and is called a Radio Network Controller (RNC). Since UMTS is a W-CDMA system, soft handoffs are supported. As a result, two base stations 6 serve one remote terminal, and the remote terminal sends frames to these two base stations. When the two base stations receive the frames from the remote terminal, they send them to a Frame Selector Unit (FSU). The FSU decides which is a better frame, in terms of frame quality, to be sent to the core network. In UMTS, the FSU may be physically integrated with the RNC and as such, in FIG. 1, the RNC and FSU are shown as block 10; but the RNC and FSU are also functionally separate and may be physically separate as represented by block 12 (FSU) and block 14 (RNC). Other elements in the UMTS network perform conventional functions such as: xLR databases 20, which provide home and visiting location information; and interworking function (IWF) units. It is to be appreciated that a Universal Mobile Switching Center (UMSC) 16 serves as the mobile switching center for the base stations 6 in the UMTS. Sub-networks 18 are wireless service provider networks and CNI through CNn are the core networks 24 to which the remote terminals are ultimately coupled.

FIG. 2, is a diagram of the typical protocol stack in UMTS. In UMTS, Layer 1 (L1) is the physical layer (PHY) which offers information transfer services to the MAC (Media Access Control) layer and higher layers. The physical layer transport services are described by how and with what characteristics data is transferred over the transport channels of the radio interface. Layer 2 (L2) comprises sublayers which include MAC, LAC (Link Access Control), and RLC and RLC′ (Radio Link Control). In UMTS, the functions performed in RLC are split and thus two RLC protocols (RLC and RLC′) are specified. The RLC and MAC layers provide real-time and non-real-time services. The MAC layer controls but does not carry out the multiplexing of data streams originating from different services. That is, the MAC layer, via logical channels, allows common physical communications channels (e.g., broadcast channel) to be shared by a number of remote terminals. IP (Internet Protocol) is the network layer.

“Uu” refers to the UMTS-specific interface between a remote terminal and a base station, while “lub” refers to the UMTS-specific interface between a base station and the RNC/FSU. Layer 2 of the radio access network (i.e., left side of NODE-B on the protocol stack) is split into RLC and MAC layers, while Layer 2 of the core network (i.e., right side of NODE-B on the protocol stack) is more related to the technology used to transport network layer frames, e.g., ATM (Asynchronous Transfer Mode) or Frame Relay. While IP is shown as the transport protocol, UMTS is not so limited. That is, UMTS can cater to other transport protocols.

Extensive information concerning UMTS is available at http://www.3gpp.org/ftp/Specs/2003-06/. Of particular interest to an understanding of the present invention are the 3GPP Technical Specifications 3GPP TS 25.201 Physical layer—General description, 3GPP TS 25.211 Physical channels and mapping of transport channels onto physical channels (FDD) and 3GPPTS 25.214 Physical layer procedures (FDD), which are incorporated herein by reference.

Because the distance between a remote terminal and the base station varies with each user, signals from different remote terminals in communication with the same base station would arrive at the base station randomly if they were not coordinated by the base station. Since signal throughput can be enhanced by coordination of the arrival time of signals from the remote terminals, the base station in a UMTS network uses control channels in both the uplink and downlink directions to control when individual remote terminals transmit and for how long. To conserve bandwidth, the control channels are shared by several users at any time. To distinguish among messages destined for different users, each message is uniquely identified by a user ID. For example, in downlink control signaling, the MAC ID, which is an identification code that uniquely identifies the Media Access Control Layer in a particular remote terminal is often used to identify control signals intended for a specific remote terminal. Thus, each remote terminal connected to the same channel listens for messages on that channel, decodes these messages to determine if the MAC ID in the message is the same as the MAC ID associated with its MAC layer, and responds to those messages having a MAC ID that is the same as the MAC ID associated with the MAC layer of the remote terminal.

Often, a remote terminal monitors for messages on multiple channels at the same time as in the case of a soft handoff described above.

### SUMMARY OF INVENTION

In view of the extensive amounts of control signaling in wireless communication systems such as UMTS, it may be desirable to provide efficient control signaling. The present invention provides for such efficiency in a downlink control channel that specifies the following information: MAC ID, HARQ channel ID, redundancy version, transport format, transport block size, new/continue data indicator and pilot boost/deboost. Optionally, the downlink control channel may also specify whether transmit time interval may be varied or fixed.

Advantageously, this information may be supplied in a subframe that may be organized so as to specify in the first part of the frame information that can be used immediately by the remote terminal and to specify in a later part of the frame information that does not have to be used immediately. In particular, information such as the transport format, transport block size and new/continue data indicator may be advantageously specified in the first part of the frame and information such as the pilot boost/deboost may be specified in a later part of the same frame.

### BRIEF DESCRIPTION OF DRAWINGS

These and other elements, features and advantages of the invention will be more readily apparent from the following Detailed Description of the Invention on which:

FIG. 1 is a schematic illustration of the UMTS Access network;

FIG. 2 is a representation of a typical protocol stack in UMTS;

FIG. 3 is a representation of the frame structure of the uplink DPDCH and uplink DPCCH in UMTS;

FIG. 4 is a representation of the frame structure of the uplink HS-DPCCH in UMTS;

FIG. 5 is a representation of a downlink subframe of the present invention; and

FIG. 6 is a block diagram of an illustrative embodiment of the invention.

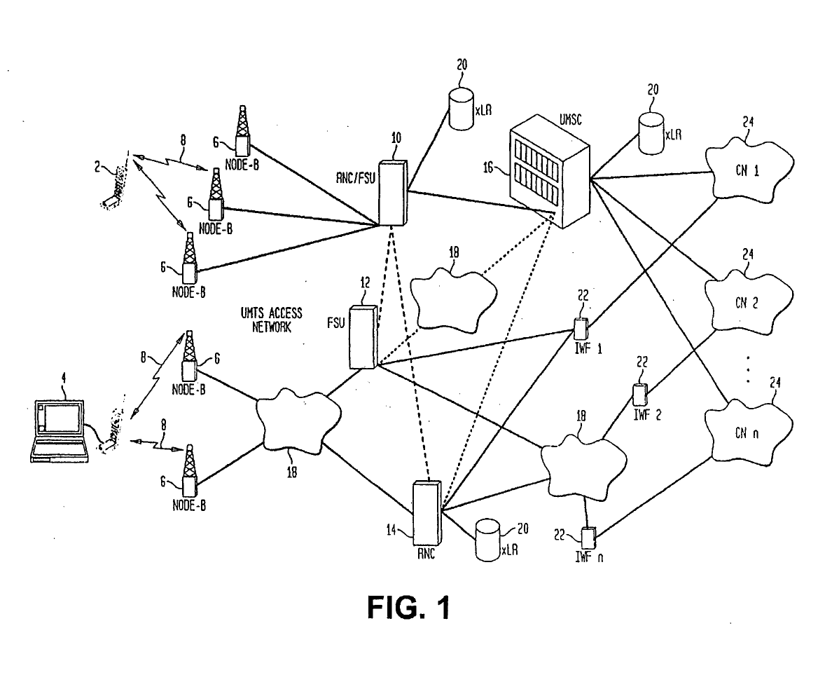

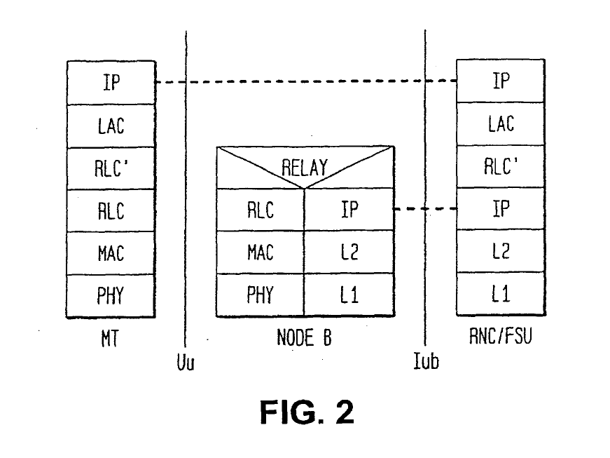

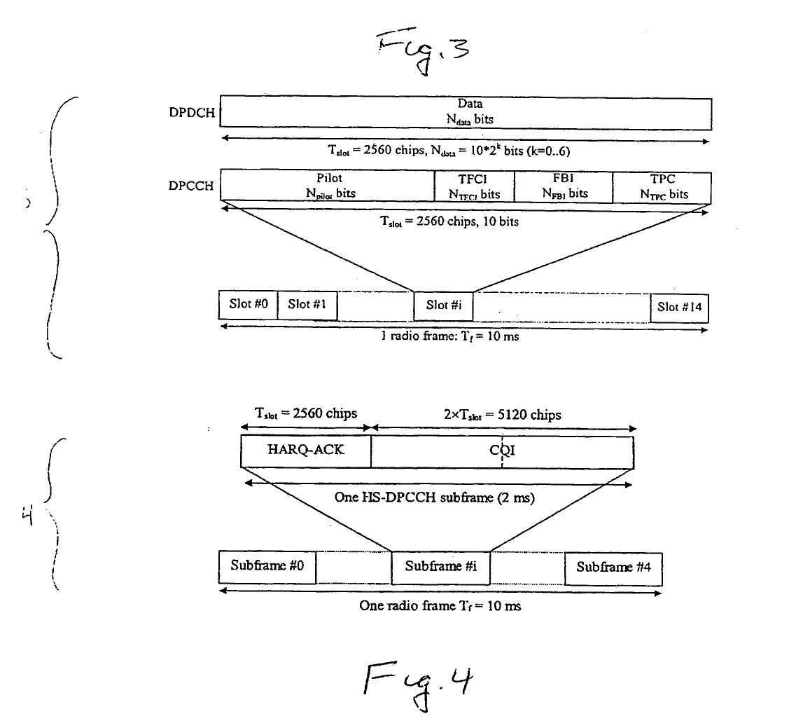

### DETAILED DESCRIPTION OF INVENTION

Communication between the remote terminals and the base stations may be conducted over two types of transport channels: common channels and dedicated channels. The common channels may include the broadcast channel (BCH), the paging channel (PCH), the forward access channel (FACH), the downlink shared channel (DSCH), the random access channel (RACH), the common packet channel (CPCH) and the uplink shared channel (USCH). BCH is a downlink channel that is used to broadcast system information to a cell. PCH is a downlink channel that is used for control information when the system does not know the cell in which the remote terminal is located. FACH is a downlink channel that is used for control information when the system knows the cell in which the remote terminal is located. DSCH is a downlink channel shared by several remote terminals to carry dedicated control or traffic data. RACH is an uplink channel that is used to carry control information from a remote terminal. CPCH is an uplink channel that is used to provide power control and CPCH commands. USCH is an uplink channel that is used to carry dedicated control or traffic data.

The present invention relates to the uplink and downlink dedicated physical channels. The dedicated downlink channels may include: the downlink dedicated physical data channel (downlink DPDCH), the downlink dedicated physical control channel (downlink DPCCH), and the downlink high speed DPCCH (downlink HS-DPCCH). The dedicated uplink channels may include: the uplink Dedicated Physical Data Channel (uplink DPDCH), the uplink Dedicated Physical Control Channel (uplink DPCCH), and the uplink high speed DPCCH (uplink HS-DPCCH). The dedicated channels may be assigned to the use of a specific remote terminal in either the downlink or uplink directions.

As set forth at page 10 of 3GPP TS 25.211: The uplink DPDCH is used to carry the DCH transport channel. There may be zero, one, or several uplink DPDCHs on each radio link. The uplink DPCCH is used to carry control information generated at Layer 1. The Layer 1 control information consists of known pilot bits to support channel estimation for coherent detection, transmit power-control (TPC) commands, feedback information (FBI), and an optional transport-format combination indicator (TFCI). The transport-format combination indicator informs the receiver about the instantaneous transport format combination of the transport channels mapped to the simultaneously transmitted uplink DPDCH radio frame. There is one and only one uplink DPCCH on each radio link.

FIG. [3] shows the frame structure of the uplink DPDCH and the uplink DPCCH. Each radio frame of length 10 ms is split into 15 slots, each of length Tₛₗₒₜ=2560 chips, corresponding to one power-control period. The DPDCH and DPCCH are always frame aligned with each other . . . .

FIG. [4] illustrates the frame structure of the HS-DPCCH. The HS-DPCCH carries uplink feedback signaling related to downlink HS-DSCH transmission. The HS-DSCH-related feedback signaling consists of Hybrid-ARQ Acknowledgement (HARQ-ACK) and Channel-Quality Indication (CQI) [3]. Each sub frame of length 2 ms (3*2560 chips) consists of 3 slots, each of length 2560 chips. The HARQ-ACK is carried in the first slot of the HS-DPCCH sub-frame. The CQI is carried in the second and third slot of a HS-DPCCH sub-frame. There is almost one HS-DPCCH on each radio link. The HS-DPCCH can only exist together with an uplink DPCCH.

In accordance with the present invention, a downlink control channel may be used in Node B scheduled mode. This channel can be monitored by multiple remote terminals served by the same node, and multiple such channel may be transmitted from a specific Node B. This channel may be called Enhanced Uplink-Shared Control Channel (EU-SCCH). Advantageously, this channel may be a fixed rate channel with spreading factor 128, for example. The following information may be carried over the EU-SCCH: MAC ID;
HARQ channel ID;
Redundancy version;
Transport Format;
Transport Block Size;
New/Continue data indicator; and
Pilot boost/deboost.

In addition, a single bit may be used to indicate if the transmission time interval is variable (e.g., 1) or fixed (e.g., 0).

As indicated above, the MAC ID indicates the remote terminal to which the message may be addressed. The HARQ ID may identify a specific process in a hybrid automatic repeat request (HARQ) process; and the redundancy version specifies which of several retransmissions is of interest. Together, the HARQ ID and redundancy version may allow the base station to specify to the remote terminal the specific HARQ process and the specific retransmission that the base station wants the remote terminal to send. The transport format specifies the correct channelization code to be used by the remote terminal in its transmission. The transport block size specifies the size of the packet to be sent by the remote terminal. The new/continue data indication if set to new indicates that a new packet is to be sent. If set to continue it indicates that a previously transmitted packet is to be sent. The pilot boost/deboost signal controls the signal level of the pilot signal to be sent from the remote terminal to the base station. In particular, the level of the pilot signal can either be increased or decreased.

For multicode CDMA system with different spreading factors for each code, the following equation holds

$$\frac{TBS}{TTI} = {\sum }_{i = 1}^{{N}_{OVSF}} ( \frac{1}{{SF}_{i}} ) * {R}_{chip} * {r}_{effective} * {log}_{2} M \qquad ( 0.1 )$$

where TBS is the transport block size, TTI is the transmission time interval, N_{OVSF} is the number of OVSF codes, SF is the spreading factor for the i-th OVSF code, R_{chip} is the chip rate, r_{effective} is the effective coding rate, and M is the number of constellation points in the modulation. The transport channel and physical channel formats indicate that for the any given slot format number the spreading factor SFs and the number of OVSF codes N_{OVSF}, and the modulation size M are fixed. Therefore, all there is left to signal for the transport format are the TTI for the given packet.

The following bit widths are preferred for the various field in the EU-SCCH for both fixed TTI and variable TTI options:
MAC ID—16 bits,
HARQ Channel ID—3 bits,
Redundancy version—3 bits,
Transport Format Number—3 bits,
Transport Block Size—3 bits,
Transmission Time Interval—1 bit (for variable TTI). 0 bit (for fixed TTI),
New data indicator—1 bit, and
Pilot boost/deboost—6 bits.

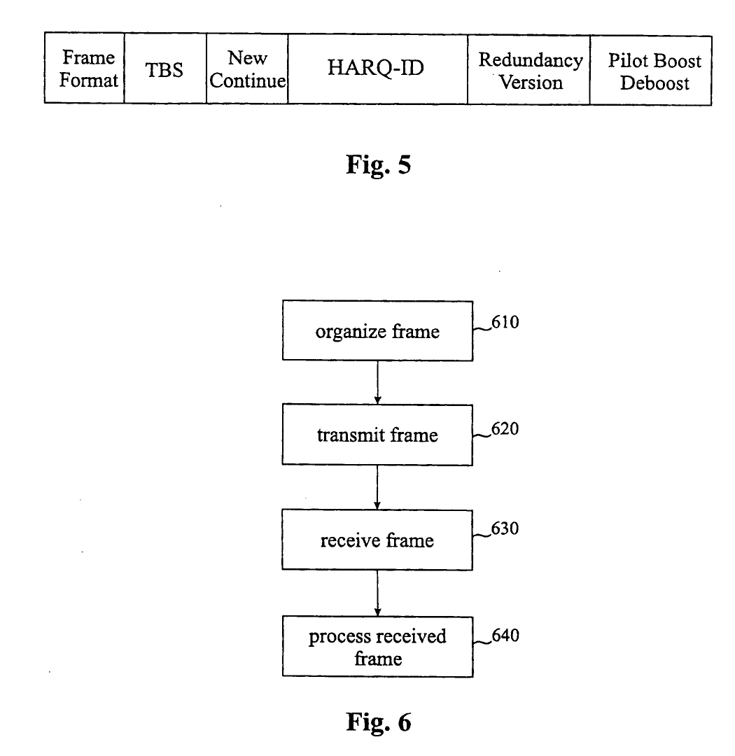

To reduce the performance penalty due to latency, the EU-SCCH frame may be organized to specify in the first part of the frame information that can be used immediately by the remote terminal while specifying in a later part of the frame information that does not need to be used immediately. In particular, information such as the transport format, transport block size and new/continue data indicator may be specified in the first part of the frame and information such as the MAC ID and the pilot boost/deboost may be specified in a later part of the same frame. In one format, the HARQ channel ID and the redundancy version may be also be specified in the first part of the frame. A frame format organized in accordance with the invention is depicted in FIG. 5.

In accordance with the invention, the frame may be used as shown in FIG. 6. At step 610 the frame may be organized at the base station with the information that can be used immediately by the remote terminal in the first part of the frame and information which need not be used in a later part of the frame. Thus, at least the frame format, transport block size and new/continue data indicator may be in the front part of the frame and the pilot boost/deboost may be in the later part of the frame. The frame may be then transmitted at step 620 to the remote terminal. At step 630, the frame may be received at the remote-terminal and it may be processed at step 640. Advantageously, processing takes advantage of the order in which the frame information was transmitted and received so that the remote terminal can begin immediately to use information such as the frame format, transport block size and new/continue data indicator specified in the frame received at the remote terminal.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention It is therefore contemplated that the appended claims will cover any such modifications or embodiments as fall within the true scope of the invention.

1. A method of control signaling in a wireless communication system comprising the steps of
transmitting in at least a first part of a frame downlink control signals specifying at least one of the following:
transport format,
transport block size, and
new/continue data indication; and
transmitting in at least a second part of the same frame following said first part specifying a change in signal level for a pilot signal.

2. The method of claim 1 further comprising the step of transmitting in the same frame a HARQ channel ID.

3. The method of claim 1 further comprising the step of transmitting in the same frame a specification of redundancy version.

4. The method of claim 1 further comprising the step of transmitting in the same frame a specification of transmission time interval.

5. The method of claim 1 further comprising the step of transmitting in the same frame a Mac ID.

6. The method of claim 1 wherein control signals specifying each of the transport format, transport block size, and new/continue data indication are transmitted in at least a first part of the frame.

7. A method of control signaling in a wireless communication system comprising the steps of
receiving at user equipment in at least a first part of a frame downlink control signals specifying at least one of the following:
transport format,
transport block size, and
new/continue data indication; and
receiving at the user equipment in a second part of the same frame following said first part downlink control signals specifying a change in signal level for a pilot signal.

8. The method of claim 7 further comprising the step of receiving in the same frame a HARQ channel ID.

9. The method of claim 7 further comprising the step of receiving in the same frame a specification of redundancy version.

10. The method of claim 7 further comprising the step of receiving in the same frame a specification of transmission time interval.

11. The method of claim 7 further comprising the step of receiving in the same frame a MAC ID.

12. The method of claim 7 wherein control signals specifying each of the transport format, transport block size and new/continue data indication are transmitted in at least a first part of the frame.

13. A communication frame for use in a wireless communication system comprising:
a HARQ channel ID,
specification of a redundancy version,
specification of a transport format number,
specification of a transport block size,
a new/continue indicator, and
specification of a change in signal level for a pilot signal.

14. The communication frame of claim 13 further comprising a MAC ID.

15. The communication frame of claim 13 wherein the specification of a change in signal level for a pilot signal is located at or near the end of the frame.

16. The communication frame of claim 13 wherein the specification of a transport format number, the specification of a transport block size, and the new/continue indicator are located near the front of the frame.

17. The communication frame of claim 13 wherein the number of bits used to specify the following elements of the frame is:

| | |
|---|---|
| transport format | 3 bits |
| transport block size | 3 bits |
| new/continue data indicator | 1 bits |
| change in signal level | 6 bits |

18. The communication frame of claim 13 wherein the number of bits used to specify the HARQ channel ID is 3 bits and the number of bits used to specify the redundancy version is 3 bits.

19. The communication frame of claim 13 further comprising a specification of a variable or a fixed transmission time interval.

20. The communication frame of claim 13 wherein bits representing a MAC ID are exclusive ORed with bits representing other information carried in the frame.
